(19) United States
(12) Patent Application Publication
(10) Pub. No.: US 2003/0101281 A1
(43) Pub. Date: May 29, 2003

(54) Communication protocol for mobile nodes in a network address translation (NAT) domain

(76) Inventors: Michael Andrews, Beaverton, OR (US); Prakash Iyer, Beaverton, OR (US); Changwen Liu, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/997,093

(22) Filed: Nov. 28, 2001

(51) Int. Cl. G06F 15/16

(52) U.S. Cl. 709/245

(57) ABSTRACT

The invention is to allow a mobile node to discover an agent in a network address translation (NAT) domain without requiring deploying foreign agents at each subnet or broadcasting in the domain.

### FIELD OF THE INVENTION

The invention generally relates to mobile communications in TCP/IP networks, and more particularly defines an agent discovery protocol for a mobile node in a NAT domain

### BACKGROUND

Due to popular demands for accessing the Internet, most networks support the Transmission Control Protocol I Internet Protocol (TCP/IP) suite. Presently, consumers and applications are driving the need for network infrastructure to allow continued access for mobile devices when the devices roam from one network to another, for example, from their “home” networks (i.e. networks that they usually connect to) to remote/foreign networks. Mobile IP is emerging as one technology to enable this ubiquitous and continuous connectivity. However, Mobile IP has its limitations when working with existing network infrastructures.

As illustrated in FIG. 1, a mobile node 110, such as a cell phone, is within a private address space 104 of a foreign domain. The stub router 108 performs a NAT function, specifically, it manages connections to and from multiple devices in the private address space 104 by translating private IP addresses to a limited set of routable wide area network (WAN) IP address. Also, the stub router 108 prevents conflicts across similar applications running on multiple devices by translating TCP and User Datagram Protocol (UDP) ports. The Home Agent (102) performs the role of an anchor for the mobile node 110 in the mobile node's home network.

Continuing on with FIG. 1, the mobile node 110 requests and receives a non-routable IP address, which is termed a co-allocated Care of Address (CoA). Unfortunately, Mobile IP does not work for FIG. 1 scenario since the mobile node's CoA is not routable in the WAN 106. More specifically, the process of the mobile node registering with the home agent from the foreign network will subsequently result in a binding update that specifies a non-routable care-of address which breaks packet routing from the Home Agent to the mobile node.

In contrast to FIG. 1 scenario, Mobile IP works for FIG. 2 scenario by a gateway foreign agent (GFA) addition in the stub router that results in a NAT+GFA router. The mobile node registers one of the stub router's globally routable addresses as the CoA with the home agent. Unfortunately, FIG. 2 scenario also has its own issue: The mobile node needs to discover GFA before it registers with the home agent. If the NAT domain has multiple subnets as shown in FIG. 2, a foreign agent may be needed at each subnet of the NAT domain where the mobile nodes may be attached. Mobile IP deployment costs are increased and scalability is limited because of the required foreign agent deployment at each subnet of the domain.

Another possible solution is realm-specific IP (RSIP), a protocol specified by IETF, to support mobile nodes by enabling “host-NATing”, for example, by allowing each host in a NAT domain to query the NAT router for NAT parameters, such as, the WAN routable IP address and translation ports and performing the translation operations on behalf of the router. However, there are at least two limitations to RSIP. First, the mobile nodes require additional logic to determine the use of non-routable or public IP addresses based at least in part on the location of the home agent. Second, the mobile nodes will require software or firmware to support the RSIP protocol.

### BRIEF DESCRIPTION OF THE DRAWINGS

The features and advantages of the present invention will become apparent from the following detailed description of the present invention in which:

FIG. 1 illustrates a network configuration of computing devices interconnected through a network in accordance with one embodiment.

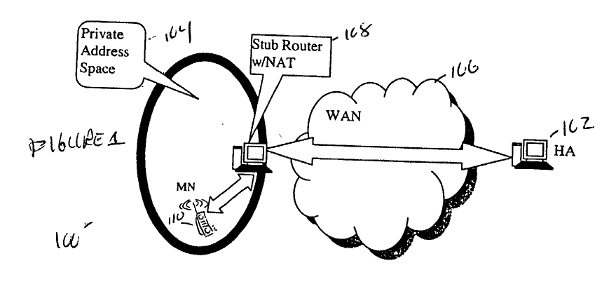

FIG. 2 illustrates a network configuration of computing devices interconnected through a network in accordance with one embodiment.

FIG. 3 illustrates a communication protocol to support a network configuration in accordance with one embodiment.

FIG. 4 illustrates a flowchart to support a communication protocol in accordance with one embodiment.

### DETAILED DESCRIPTION

In one embodiment, the previously discussed limiting factors, such as, utilizing foreign agents throughout the NAT domain subnets and requiring mobile nodes to analyze the address types and utilize software to enable the RSIP protocol can be overcome by utilizing an agent discovery protocol. Specifically, the agent discovery protocol filters outbound Mobile IP registration requests to determine whether the registration is for a private CoA; And if yes, it notifies the registration sender with a routable address to alter the CoA in the later requests from the registration sender. As used herein, the term “NAT” refers to any access point that alters origin and/or port values of passing network traffic.

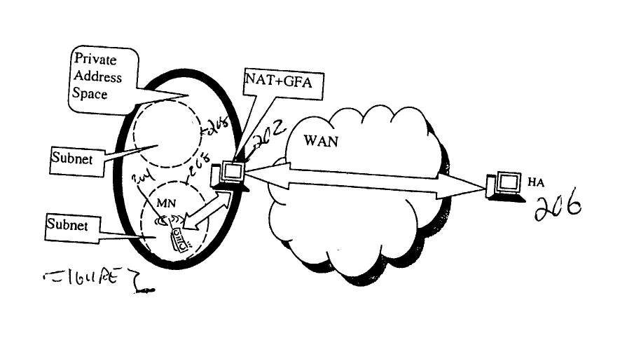

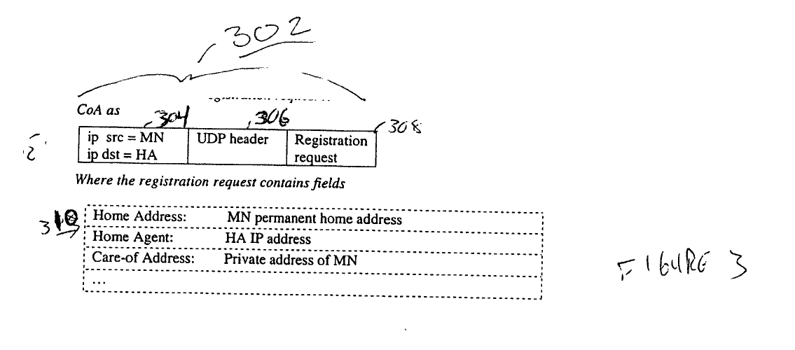

FIG. 3 is a communication protocol to support a network configuration in accordance with one embodiment. In one embodiment, the communication protocol supports the network configuration depicted in FIGS. 2. The mobile node depicted in FIG. 2 may incorporate a variety of communication or computing devices, such as, a personal digital assistant (PDA), an Internet tablet, a laptop computer, as well as the previously described cell phone.

The communication protocol depicts a registration request 302 that contains three fields, specifically, an IP field 304, a UDP header field 306, and a registration request field 308. In one embodiment, the IP field designates the mobile node as the source of the request and the home agent as the destination of the request.

The registration request field 308 is illustrated in more detail in block 310. In one embodiment, the registration field 308 may contain a home address that specifies the mobile node's permanent or dynamically assigned home address; a home agent that specifies the home agent's IP address; and a Care of Address field that specifies the non-routable address of the mobile node. However, the invention is not limited to the previously described fields. For example, a communication protocol may incorporate less than three fields by combining some of the fields. Alternatively, the communication protocol supports more than three fields by appending multiple registration requests.

The processing of the registration request utilizes various elements depicted in FIG. 2. For example, the registration request 302 is forwarded to the NAT+GFA router of FIG. 2. The NAT+GFA router analyzes the registration request 302 to determine if the CoA in the request field 308 is a non-routable address.

If the CoA is a non-routable address, the NAT+GFA router drops (discards) the request 302. In one embodiment, the NAT+GFA router transmits mobile agent unicast advertisement message(s) for the gateway foreign agent (GFA) to mobile node, which specifies a routable NAT+GFA address and allows the mobile node to use foreign agent assisted routing. One option to this embodiment is for the NAT+GFA router to also transmit an error code back to the non-routable address of the mobile node for indicating an invalid CoA.

Alternatively, in another embodiment, if the CoA is a non-routable address, then the NAT+GFA router broadcasts mobile agent advertisement message(s) that specifie(s) a routable NAT+GFA address, for the gateway foreign agent (GFA) to the subnet derived from the non-routable address of the registration request. One option to this embodiment is for the NAT+GFA router to also transmit an error code back to the subnet of the mobile node for indicating an invalid CoA.

Otherwise, if the CoA is not a non-routable address, the NAT+GFA router forwards the registration request 302 to the home agent via the WAN and the previously discussed Mobile IP process is performed. In one aspect, the claimed subject matter offers the advantage of eliminating the need for additional mobile agents throughout the NAT domain. Likewise, another advantage of the claimed subject matter supports standard Mobile IP registration messages and standard data packet routing is unaltered. In one embodiment, no additional changes to a Mobile IP enabled mobile nodes are needed.

Continuing on with the processing in the case where the CoA contains a non-routable address, the mobile agent advertisement message has been forwarded to the mobile node. Upon receipt of the advertisement message, the mobile node creates a new registration request with a hierarchical foreign agent extension that specifies a new CoA address, which is the routable NAT +GFA router address. Subsequently, the new registration message with the NAT+GFA router address as the specified CoA address is forwarded to the router and the registration request is processed and forwarded to the home agent via the WAN.

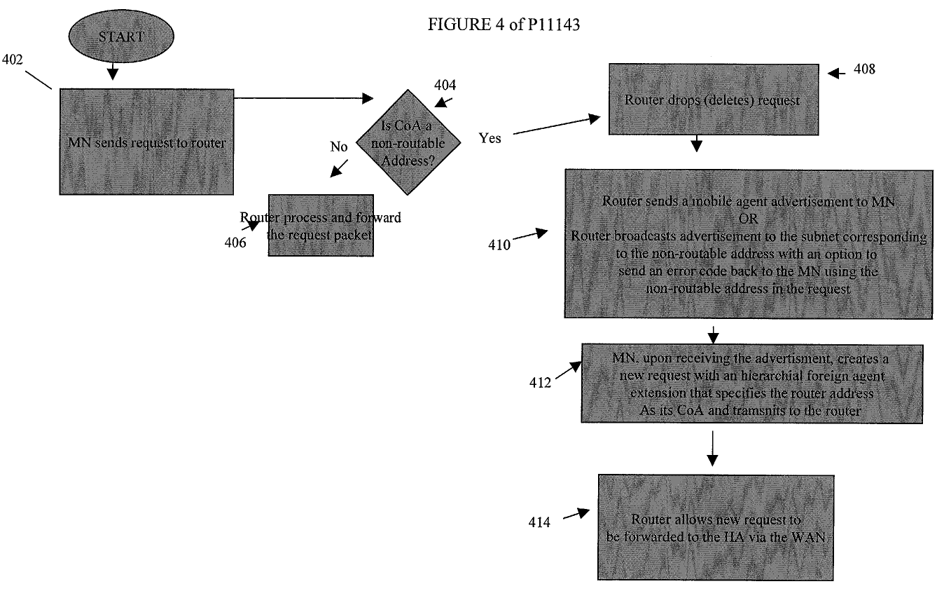

FIG. 4 illustrates a flowchart to support a communication protocol in accordance with one embodiment. This flowchart merely illustrates one example of a method for the agent discovery protocol previously described in connection with FIG. 3. Block 402 depicts a mobile node that sends a registration request to a NAT+GFA router with a CoA that has a non-routable address. In one example, the registration request in block 402 is similar to the request 302 depicted in FIG. 3. Subsequently in decision block 404, the router determines if the CoA of the registration request is a non-routable address. If not, the case the address is routable, block 406 allows the router to process the packet. Otherwise, the case the address is non-routable, the block 408 allows the router to drop or delete the registration request.

Continuing on, block 410 allows for two options. Either the router sends a mobile agent advertisement to the mobile node OR the router broadcasts advertisment to the subnet corresponding to the non-routable address, with the option to send an error code back to the mobile node with the non-routable address in the request. Subsequently, block 412 depicts the case where the mobile node, after it receives the advertisement, may create a new registration request with a hierarchical foreign agent extension that specifies a new CoA address, which is the routable NAT+GFA router address. Also, the mobile node transmits the new request to the router. Block 414 depicts the router forwarding the new request to the home agent via the WAN. The claimed subject matter is not limited in scope to the previous flowchart. The flowchart depicts one example of implementing the agent discovery protocol and can support modifications.

Having described and illustrated the principles of the invention with reference to illustrated embodiments, it will be recognized that the illustrated embodiments can be modified in arrangement and detail without departing from such principles. For example, GFA may be in a separate box. Another example is the GFA may be in a separate box with at least 1 routable WAN IP address distinct from the routable IP address assigned to the NAT router.

And, even though the foregoing discussion has focused on particular embodiments, it is understood that other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments, and unless implicitly or expressly indicated otherwise, embodiments are combinable into other embodiments. Consequently, in view of the wide variety of permutations to the above-described embodiments, the detailed description is intended to be illustrative only, and should not be taken as limiting the scope of the invention.

What is claimed as the invention, therefore, is all such modifications as may come within the scope and spirit of the following claims and equivalents thereto.

What is claimed is:

1. An apparatus to allow a node to locate an agent in a network address translation (NAT) domain, the apparatus comprising:
a network translation device to receive a first request from the node;
the network translation device to determine whether an first address of the first request is a non-routable address; and
if so, to discard the first request and to broadcast a message to the agent.

2. The apparatus of claim 1, further comprising:
the network translation device to forward the first request to a home agent if the first address of the first request is not the non-routable address, the home agent coupled to the network translation device via a wide area network (WAN).

3. The apparatus of claim 1, wherein the node is a mobile node and is either one of a cellular phone, laptop computer, personal digital assistant (PDA), or an Internet table.

4. The apparatus of claim 1, wherein the agent is a gateway foreign agent (GFA).

5. The apparatus of claim 1, wherein the network translation device is a router to support NAT and GFA functionality.

6. The apparatus of claim 1, wherein the first address is a Care of Address (CoA).

7. The apparatus of claim 1, wherein the message is a mobile agent advertisement unicast message for the GFA to allow the node to use foreign assisted routing.

8. The apparatus of claim 1, wherein the message is a mobile agent advertisement unicast message for the GFA to a subnet, the subnet coupled to the network translation device and is derived from a second address of the first request.

9. The apparatus of claim 1, wherein the first request is a registration request of the node to the home agent.

10. The apparatus of claim 7, wherein the node, subsequent to the advertisement, is to generate a second request with a first address to be derived from an address of the network translation device, and the network translation device to forward the second request to the home agent via the WAN.

11. The apparatus of claim 7, wherein to broadcast the message to the agent, the network translation device forwards an error code to the mobile node derived from the second address of the first request.

12. The apparatus of claim 8 wherein the node, subsequent to the advertisement, is to generate a second request with a first address to be derived from an address of the network translation device, and the network translation device to forward the second request to the home agent via the WAN.

13. The apparatus of claim 8, wherein the network translation device forwards an error code to the mobile node derived from the second address of the first request.

14. The apparatus of claim 10, wherein the second request is a registration request of the node to the home agent.

15. The apparatus of claim 12, wherein the second request is a registration request of the node to the home agent.

16. A method for locating an agent for a node in a network address translation (NAT) domain, comprising:
generating a first request from the node;
forwarding the first request to a network translation device; and determining whether a first address of the first request is a non-routable address, if so, deleting the first request and broadcasting a message to the agent.

17. The method of claim 16, further comprising:
forwarding the first request to a home agent if the first address of the first request is not the non-routable address, the home agent coupled to the network translation device via a wide area network (WAN).

18. The method of claim 16, wherein the node is a mobile node and is either one of a cellular phone, laptop computer, personal digital assistant (PDA), or an Internet table.

19. The method of claim 16, wherein the agent is a gateway foreign agent (GFA) and the network translation device is a router to support NAT and GFA functionality.

20. The method of claim 16, wherein the first address is a Care of Address (CoA) and the message is a mobile agent advertisement unicast message.

21. The method of claim 16, wherein the first request is a registration request of the node to the home agent.

22. The method of claim 16, wherein broadcasting the message to the agent:
the message is a mobile agent advertisement unicast message for the GFA to a subnet, the subnet coupled to the network translation device and is derived from a second address of the first request; and
the node, subsequent to the advertisement, is to generate a second request with a first address to be derived from an address of the network translation device, and the network translation device to forward the second request to the home agent via the WAN.

23. The method of claim 22 wherein the second request is a registration request of the node to the home agent.

24. An article comprising:
a storage medium having stored thereon instructions, that, when executed by a computing platform, result in execution of locating an agent for a node in a network address translation (NAT) domain by:
generating a first request;
forwarding the first request to a network translation device;
determining whether a first address of the first request is a non-routable address, if not, forwarding the first request to a home agent, the home agent coupled to the network translation device via a wide area network (WAN).

25. The article of claim 24, further comprising:
if the first address of the first request is the non-routable address,
deleting the first request and broadcasting a message to the agent; and
generating a second request wherein a first address of the second request is the address of the network translation device.

26. The article of claim 24 wherein the node is a mobile node and is either one of a cellular phone, laptop computer, personal digital assistant (PDA), or an Internet table.

27. The article of claim 24 wherein the first address is a Care of Address (CoA) and the message is a mobile agent advertisement unicast message.

28. The article of claim 24 wherein the first request is a registration request of the node to the home agent.

29. The article of claim 25 wherein broadcasting the message to the agent:
the message is a mobile agent advertisement unicast message for the GFA to a subnet, the subnet coupled to the network translation device and is derived from a second address of the first request; and
the node, subsequent to the advertisement, is to generate a second request with a first address to be derived from an address of the network translation device, and the network translation device to forward the second request to the home agent via the WAN.

30. The article of claim 29 wherein the second request is a registration request of the node to the home agent.

31. A method for allowing a node to locate an agent in a network address translation (NAT) domain, the method comprising:
transmitting a first request from the node to a network translation device;
determining whether an first address of the first request is a non-routable address; and
if so, deleting the first request and broadcasting a message to the agent.

32. The method of claim 31, further comprising:
forwarding the first request from the network translation device to a home agent if the first address of the first request is not the non-routable address, the home agent coupled to the network translation device via a wide area network (WAN).

33. The method of claim 31, wherein the node is a mobile node and is either one of a cellular phone, laptop computer, personal digital assistant (PDA), or an Internet table.

34. The method of claim 31, wherein the agent is a gateway foreign agent (GFA).

35. The method of claim 31, wherein the network translation device is a router to support NAT and GFA functionality.

36. The method of claim 31, wherein the first address is a Care of Address (CoA).

37. The method of claim 31, wherein the message is a mobile agent advertisement unicast message for the GFA to allow the node to use foreign assisted routing.

38. The method of claim 31, wherein the message is a mobile agent advertisement unicast message for the GFA to a subnet, the subnet coupled to the network translation device and is derived from a second address of the first request.

39. The method of claim 31, wherein the first request is a registration request of the node to the home agent.

40. The method of claim 37, wherein the node, subsequent to the advertisement, is to generate a second request with a first address to be derived from an address of the network translation device, and the network translation device to forward the second request to the home agent via the WAN.

41. The method of claim 37, wherein to broadcast the message to the agent, the network translation device forwards an error code to the mobile node derived from the second address of the first request.

42. The method of claim 38 wherein the node, subsequent to the advertisement, is to generate a second request with a first address to be derived from an address of the network translation device, and the network translation device to forward the second request to the home agent via the WAN.

43. The method of claim 38, wherein the network translation device forwards an error code to the mobile node derived from the second address of the first request.

44. The method of claim 40, wherein the second request is a registration request of the node to the home agent.

45. The method of claim 42, wherein the second request is a registration request of the node to the home agent.
